(19) United States
(12) Patent Application Publication
(10) Pub. No.: US 2014/0329116 A1
(43) Pub. Date: Nov. 6, 2014

(54) BATTERY PACK

(71) Applicant: SAMSUNG SDI CO., LTD., Yongin-si (KR)

(72) Inventor: Bo-Hyun Byun, Yongin-si (KR)

(73) Assignee: SAMSUNG SDI CO., LTD., Yongin-si (KR)

(21) Appl. No.: 14/188,615

(22) Filed: Feb. 24, 2014

(30) Foreign Application Priority Data
May 3, 2013 (KR) 10-2013-0050321

(51) Int. Cl. H01M 10/42

(52) U.S. Cl. CPC H01M 10/425; H01M 2010/4271; H01M 2200/106
USPC 429/61

(57) ABSTRACT

A battery pack includes a bare cell, a protective circuit module, and a protection device. The protective circuit module is located on the bare cell in parallel with the protective circuit module, and includes a first connecting portion extending between a first surface of the protective circuit module and the bare cell and electrically connected to the bare cell, and a second connecting portion electrically connected to a second surface of the protective circuit module opposite to the first surface. Accordingly, the protection device and the protective circuit module are parallel to each other, allowing for a compact and lightweight structure of the battery pack with improved safety features.

### CROSS-REFERENCE TO RELATED APPLICATION

This application claims priority to and the benefit of Korean Patent Application No. 10-2013-0050321, filed on May 3, 2013, in the Korean Intellectual Property Office, the entire contents of which is incorporated herein by reference in its entirety.

### BACKGROUND

1. Field

An aspect of the present invention relates to a battery pack using secondary batteries or bare cells.

2. Description of the Related Art

Secondary batteries have recently been used as power sources for various portable electronic devices. As portable electronic devices are used in varying fields, demands on secondary batteries have rapidly increased. Because secondary batteries can be charged/discharged a plurality of times, they are economically and environmentally more efficient. Accordingly, use of battery packs using secondary batteries is often encouraged.

Demand for smaller size and lighter weight electronic devices results in a demand for smaller size and lighter weight secondary batteries. However, since a secondary battery generally comprises materials such as lithium, having high reactivity, decreasing the size and weight of the secondary battery is limited due to safety concerns. Accordingly, a variety of studies have been conducted to develop a battery pack that can implement a small and light battery unit comprised of secondary batteries, while improving the safety of the secondary battery.

Sometimes, battery packs further include various protection devices, etc., to improve safety thereof.

### SUMMARY

One or more embodiments of the present invention relate to a battery pack employing a light-weight, compact structure.

Embodiments of the present invention also relate to a battery pack including a protection device improving the safety, thereof.

According to an aspect of the present invention, a battery pack includes a bare cell; a protective circuit module on the bare cell; and a protection device on the bare cell in parallel with the protective circuit module, the protection device including a first connecting portion extending between a first surface of the protective circuit module and the bare cell and electrically connected to the bare cell, and a second connecting portion electrically connected to a second surface of the protective circuit module opposite to the first surface.

The battery pack may further include an adhesive member disposed between the protection device and the bare cell.

The protection device of the battery pack may further include a body portion; wherein the first connecting portion extends from a first surface of the body portion, and is parallel to the first surface of the protective circuit module; and where the second connecting portion extends from a second surface of the body portion, and is parallel to the second surface of the protective circuit module.

The second connecting portion of the battery pack may have an extending portion configured to electrically connect the second surface of the protective circuit module to the second connecting portion.

The first connecting portion of the battery pack may include a first area extending from the first surface of the body portion; and a second area extending from the first area and stepped a distance with respect to the first area. The second area may be connected to a negative electrode terminal of the bare cell.

The battery pack may further include an adhesive member between the protection device and the bare cell. A distance to a bottom surface of the second area of the first connecting portion, including a difference in height between the second and first areas and an added height of the adhesive member between the protection device and the bare cell, may be identical to a height of the negative electrode terminal of the bare cell.

The second connecting portion of the battery pack may include a first area positioned on the second surface of the body portion, and a second area extending from the first area and configured to be bent along an axis of the first area.

The second area of the second connecting portion of the battery pack may be configured to be bent perpendicularly with respect to the first area of the second connecting portion.

The second area of the second connecting portion of the battery pack may extend in a direction away from the bare cell.

The second connecting portion of the battery pack may further include an extending portion configured to electrically connect the second surface of the protective circuit module to the second connecting portion. The extending portion may include a first area electrically connected to and parallel with the second area of the second connecting portion, and a second area bent from the first area toward, and electrically connected to, the second surface of the protective circuit module.

A resistance of the body portion may be changed in correlation with a temperature of the bare cell.

The bare cell of the battery pack may include a negative electrode terminal, and the first connecting portion may be connected to the negative electrode.

Other features and advantages of embodiments of the present invention will become more fully apparent from the following detailed description, taken in conjunction with the accompanying drawings.

Terms or words used in this specification and claims should not be restrictively interpreted as ordinary meanings or dictionary-based meanings, but should be interpreted as meanings and concepts conforming to the scope of the present disclosure on the basis of the principle that an inventor can properly define the concept of a term to describe and explain his or her invention in the best manner.

According to embodiments of the battery pack of the present invention, the protection device is disposed in parallel with the protective circuit module, thereby implementing the miniaturization and lightweight design of the battery pack.

Further, the first connecting portion of the protection device, according to embodiments of the battery pack, is connected to the bare cell by extending over a space between the protective circuit module and the bare cell, and the second connecting portion of the protection device is connected to the protective circuit module, more safely protecting the battery pack.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a perspective view of a battery pack according to an embodiment of the present invention.

FIG. 2 is an exploded perspective view of the battery pack shown in FIG. 1.

FIG. 3 is a cross-sectional view of the battery pack shown in FIG. 1.

FIG. 4 is a perspective view of a protection device of the battery pack shown in FIG. 1.

FIG. 5 is a perspective view of the protection device shown in FIG. 4 according to an embodiment having an extending portion.

### DETAILED DESCRIPTION

In the following detailed description, only certain exemplary embodiments of the present invention have been shown and described, by way of illustration. As those skilled in the art would realize, the described embodiments may be modified in various ways, all without departing from the spirit or scope of the present invention. Accordingly, the drawings and description are to be regarded as illustrative in nature and not restrictive. In addition, when an element is referred to as being “on” another element, it can be directly on the another element, or it can be indirectly on the another element with one or more intervening elements interposed therebetween. Also, when an element is referred to as being “connected to” another element, it can be directly connected to the another element, or it can be indirectly connected to the another element with one or more intervening elements interposed therebetween. Hereinafter, like reference numerals refer to like elements.

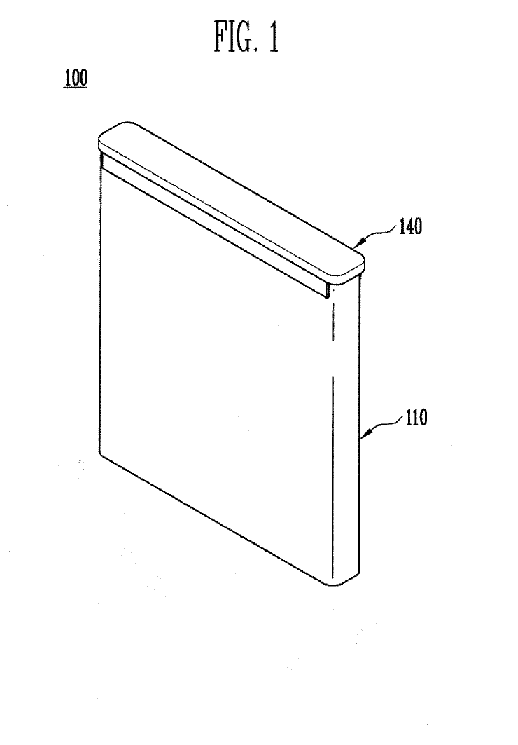

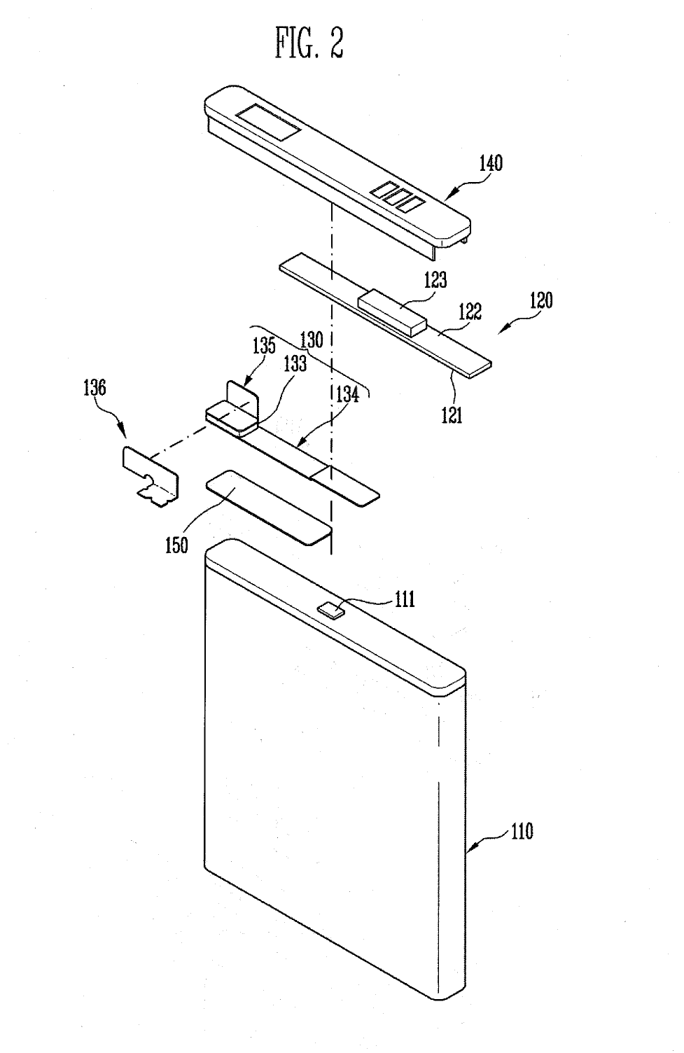

FIG. 1 is a perspective view of a battery pack 100 according to an embodiment of the present invention. FIG. 2 is an exploded perspective view of the battery pack 100 shown in FIG. 1. Hereinafter, the battery pack 100 according to this embodiment will be described with reference to FIGS. 1 and 2.

As shown in FIGS. 1 and 2, the battery pack 100 according to this embodiment includes a bare cell 110, a protective circuit module 120 positioned on the bare cell 110, and a protection device 130 including a first connecting portion 134 and a second connecting portion 135. The protection device 130 may be positioned in parallel with the protective circuit module 120 on the bare cell 110.

The bare cell 110 is a member that generates electrochemical energy through the movement of ions or electrons.

The bare cell 110 may be manufactured by accommodating an electrode assembly and an electrolyte in a battery case. In these embodiments, the electrode assembly is formed by winding or stacking a positive electrode plate, a negative electrode plate, and a separator interposed therebetween. The electrode assembly may generate energy through an electrochemical reaction between the electrode assembly and the electrolyte, supplying the generated energy to an outside of the bare cell 110 through an electrode terminal, etc. In some embodiments, the battery case may be formed as a pouch, or having a prismatic or cylindrical shape.

In some embodiments, a negative electrode terminal 111, for example, may protrude from the bare cell 110. The negative electrode terminal 111 may be electrically connected to the first connecting portion 134 of the protection device 130.

The protective circuit module 120 is a member which is positioned on the bare cell 110 to control voltage or current flow when the bare cell 110 is charged/recharged and/or discharged.

The protective circuit module 120 may include a circuit board having a circuit pattern formed therein, and having several electronic components 123 mounted on one surface of the protective circuit module 120. In this embodiment, the electronic components 123 may include a field effect transistor (FET), an integrated circuit (IC), etc. The electronic components 123 may perform several functions, including controlling the electrode assembly in the bare cell 110 or cutting off a circuit when the electrode assembly is abnormally operated. The circuit board of the protective circuit module 120 may include a switching circuit, allowing more efficient control or protection of the battery pack 100 together with the electronic components 123. Specifically, the protective circuit module 120 may block overcharging/recharging, over-discharging, overcurrent, short circuit, and reverse voltage of the battery pack 100, in order to prevent the deterioration of the battery pack 100 due to an explosion, overheating, leakage, and charging/recharging/discharging characteristics of the battery pack 100, and to limit the degradation of electrical performance or abnormal operation of the battery pack 100. Accordingly, this embodiment eliminates several risk factors, and may extend the life of the battery pack 100.

The protection device 130 is a member positioned on the protective circuit module 120 to sense a temperature of the battery pack 100, and in response to heightened temperature, cut off current flow by increasing resistance.

In a related art battery pack, a positive temperature coefficient (PTC) device was placed at a position between a protective circuit module and a bare cell, i.e., on a lower surface of the protective circuit module, requiring a space corresponding to the thickness of the PTC device between the protective circuit module and the bare cell. However, in the embodiments of the present invention, the protection device 130 is not located on a lower surface of the protective circuit module 120, but rather in parallel with the protective circuit module 120 on the bare cell 110, so that a space is not required between the bare cell 110 and a first surface 121 of the protective circuit module 120 adjacent to the bare cell 110. More specifically, the bare cell 110 and the protective circuit module 120 are coupled much more closely together other as compared with the existing bare cell and protective circuit module. Thus, in the embodiments of the present invention, the battery pack 100 may be more compact and light-weight, as no additional spacing between the bare cell 110 and the protective circuit module 120 is required. In addition, in this embodiment, since there is no additional spacing between the bare cell 110 and the protective circuit module 120, the safety of the battery pack 100 can be improved. Further, the protective circuit module 120 may be coupled more closely to one end of the bare cell 110, having an unnecessary portion of the protective circuit module 120 removed at the other end and placing the protection device 130 at the other end of the bare cell 110, which allows the protection device 130 to also be coupled more closely to the bare cell 110, thereby further improving the space efficiency and safety of the battery pack 100.

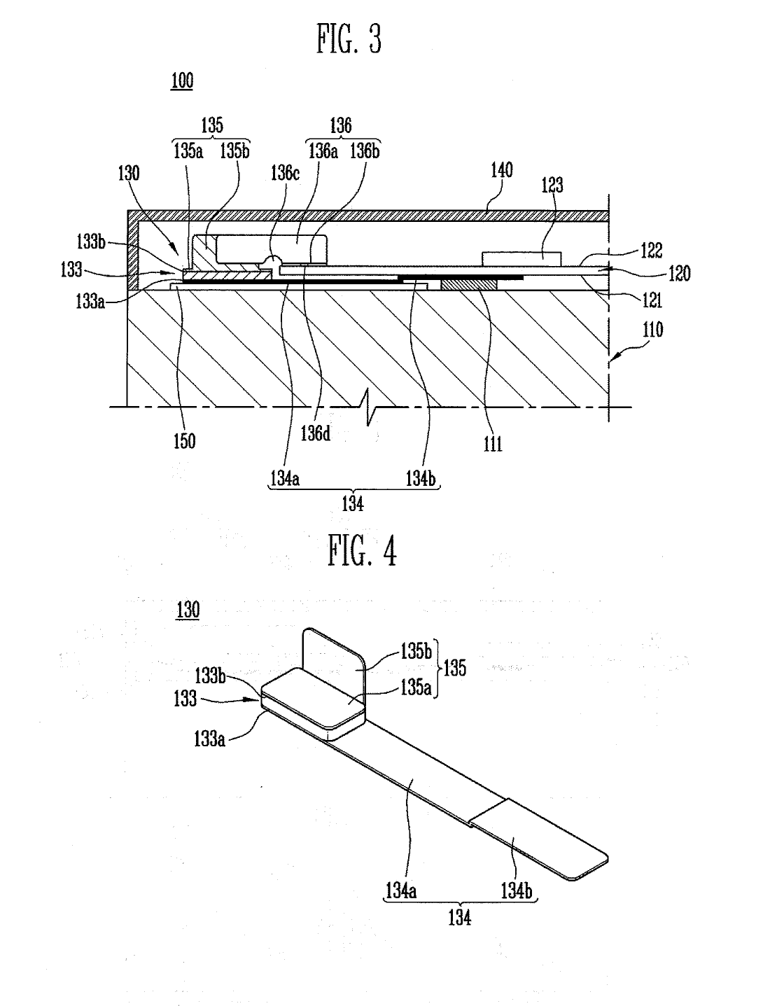

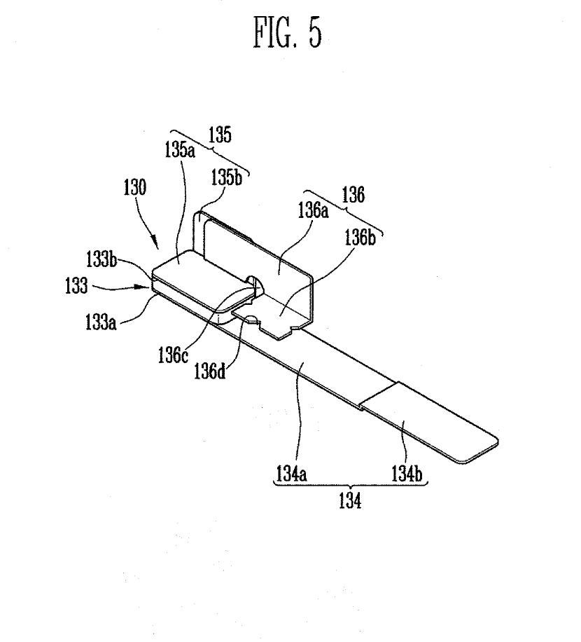

FIG. 3 is a cross-sectional view of the battery pack 100 shown in FIG. 1. FIG. 4 is a perspective view of the protection device 130 of the battery pack 100 shown in FIG. 1. FIG. 5 is a perspective view of the protection device 130 shown in FIG. 4 according to an embodiment having an extending portion 136. Hereinafter, the protection device 130 according to this embodiment will be described in detail with reference to FIGS. 3 to 5.

As shown in FIGS. 3 and 4, the protection device 130 may include a body portion 133, a first connecting portion 134 extending from a first surface 133a of the body portion 133, and a second connecting portion 135 extending from a second surface 133b of the body portion 133.

The body portion 133 is a member which adjusts resistance depending on the temperature of the battery pack 100, and may be part of the protection device 130.

In some embodiments, the body portion 133 includes a device which adjusts resistance corresponding with a change in the temperature of the battery pack 100, as measured by the body portion 133. The body portion 133 may use, for example, a PTC device. In an embodiment, if the temperature of the battery pack 100 increases, the resistance of the body portion 133 may also be increased together with the increased temperature of the battery pack 100. In this embodiment, if heat is excessively generated from the battery pack 100, the current flowing through the first and second connecting portions 134 and 135 can be cut off.

In some embodiments, the body portion 133 may be configured to measure a temperature of the bare cell 110 of the battery pack 100. The body portion 133 may be configured to have connectors respectively provided at both sides thereof, so that the first and second connecting portions 134 and 135 are electrically connected to the respective connectors.

The first connecting portion 134 is a member extending from the first surface 133a of the body portion 133, and may electrically connect the bare cell 110 to the body portion 133.

In these embodiments, the first connecting portion 134 may be extended from the first surface 133a of the body portion 133, which is parallel to the first surface 121 of the protective circuit module 120 adjacent to the bare cell 110 and connected to the negative electrode terminal 111. In addition, the first connecting portion 134 may extend into a space between the bare cell 110 and the first surface 121 of the protective circuit module 120, electrically connecting to the negative electrode terminal 111 of the bare cell 110. In this embodiment, the negative electrode terminal 111 protrudes higher than an upper surface of the bare cell 110, and corresponding with a shape of the first connecting portion 134.

In this embodiment, the first connecting portion 134 is divided into a first area 134a and a second area 134b, and the first and second areas 134a and 134b may be stepped. Specifically, the first area 134a extends from the first surface 133a of the body portion 133, and the second area 134b extends from the first area 134a, wherein the second area 134b may be stepped with respect to the first area 134a. In other words, the second area 134b may extend from a position higher than the first area 134a. Accordingly, the second area 134b may be positioned on the negative electrode terminal 111 of the bare cell 110, and electrically connected to the negative electrode terminal 111. In this embodiment, the first area 134a forms a bottom of the protection device 130 and may be closely coupled to the upper surface of the bare cell 110. For example, the first area 134a may be fixed to the upper surface of the bare cell 110 with an adhesive member 150, for example an insulative adhesive member. In this embodiment, the adhesive member 150 is positioned corresponding to the first area 134a so that the first area 134a is not electrically connected to a can of the bare cell 110, which has a positive polarity. In this embodiment, a distance to a bottom surface of the second area 134b, including the difference in height between the second and first areas 134b and 134a and the added height of the adhesive member 150 under the first area 134a, may be identical to a height of the negative electrode terminal 111 such that the bottom surface of the second area 134b may be closely coupled to the negative electrode terminal 111.

In some embodiments, the first connecting portion 134 may be made of an electrically conductive material such as gold, silver, copper, or nickel. The first connecting portion 134 and the negative electrode terminal 111 of the bare cell 110 may be connected, for example, through welding, etc. The first connecting portion 134 of the protection device 130 may be stepped perpendicularly with respect to the second connecting portion 135 as shown in FIG. 4, or may be stepped with an incline with respect to the second connecting portion 135.

The second connecting portion 135 is a member extending from the second surface 133b of the body portion 133, and may electrically connect the body portion 133 and the protective circuit module 120.

In these embodiments, the second connecting portion 135 may extend from the second surface 133b opposite to the first surface 133a of the body portion 133, which is parallel to a second surface 122, opposite to the first surface 121, of the protective circuit module 120. The second connecting portion 135 may be electrically connected to the second surface 122 of the protective circuit module 120. In this embodiment, the second connecting portion 135 may be an “L” shape and may be connected to the second surface 122 of the protective circuit module 120 through the “L” shaped extending portion 136, as shown in FIG. 5.

Specifically, the second connecting portion 135 may be divided into a first area 135a located on the second surface 133b of the body portion 133, and a second area 135b extending from the first area 135a and configured to be bent along an axis of the first area 135a. In this embodiment, the second area 135b may be bent perpendicularly with respect to the first area 135a, for example, in a direction toward from the bare cell 110. In another embodiment, the second area 135b may extend in a direction away from the bare cell 110. The extending portion 136 may be divided into a first area 136a connected in parallel with the second area 135b of the second connecting portion 135, and a second area 136b bent from the first area 136a and electrically connected to the circuit pattern on the second surface 122 of the protective circuit module 120. In this embodiment, the first and second areas 136a and 136b of the extending portion 136, as shown in FIG. 3, may have different widths, and a width of the first area 136a may be wider than a width of the second area 136b. Thus, the first area 136a of the extending portion 136, in an embodiment where the width of the first area 136a is wider than the width of the second area 136b, may overlap with the second area 135b of the second connecting portion 135.

However, the shapes of the second connecting portion 135 and the extending portion 136 are not necessarily limited thereto. In some embodiments, the second connecting portion 135 may be electrically connected to the second surface 122 of the protective circuit module 120. Alternatively, in other embodiments, the second connecting portion 135 and the extending portion 136 may be integrally connected to each other.

In some embodiments, a groove 136c may be located corresponding to a space between the protective circuit module 120 and the protection device 130 in the first area 136a of the extending portion 136. The groove 136c may aid in avoiding interference of the extending portion 136 with the protective circuit module 120 during the connection of extending portion 136 to the second surface 122 of the protective circuit module 120. In addition, a groove portion 136d may be located at an end portion of the second area 136b of the extending portion 136, i.e., a portion directly connected to the second surface 122 of the protective circuit module 120. The groove portion 136d may provide convenience or ease of access when the protective circuit module 120 is soldered to the extending portion 136.

In some embodiments, an upper cover 140 (see FIGS. 1 to 3) may be located above the protection device 130 and the protective circuit module 120 to protect the protection device 130 and the protective circuit module 120 in the battery pack 100.

Example embodiments have been disclosed herein, and although specific terms are employed, they are used and are to be interpreted in a generic and descriptive sense only, and not for the purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments, unless otherwise specifically indicated. Accordingly, it will be understood by those of skill in the art that various changes in form and details may be made without departing from the spirit and scope of the present invention as set forth in the following claims.

What is claimed is:

1. A battery pack comprising:
a bare cell;
a protective circuit module on the bare cell; and
a protection device on the bare cell in parallel with the protective circuit module, the protection device comprising a first connecting portion extending between a first surface of the protective circuit module and the bare cell and electrically connected to the bare cell, and a second connecting portion electrically connected to a second surface of the protective circuit module opposite to the first surface.

2. The battery pack of claim 1, further comprising an adhesive member located between the protection device and the bare cell.

3. The battery pack of claim 1, wherein the protection device further comprises:
a body portion;
wherein the first connecting portion extends from a first surface of the body portion, the first surface of the body portion being parallel to the first surface of the protective circuit module; and
wherein the second connecting portion extends from a second surface of the body portion, the second surface of the body portion being parallel to the second surface of the protective circuit module.

4. The battery pack of claim 3, wherein the second connecting portion has an extending portion configured to electrically connect the second surface of the protective circuit module to the second connecting portion.

5. The battery pack of claim 3, wherein the first connecting portion comprises:
a first area extending from the first surface of the body portion; and
a second area extending from the first area and stepped a distance with respect to the first area,
wherein the second area is connected to a negative electrode terminal of the bare cell.

6. The battery pack of claim 5, further comprising an adhesive member between the protection device and the bare cell,
wherein a distance to a bottom surface of the second area of the first connecting portion including a difference in height between the second and first areas and an added height of the adhesive member between the protection device and the bare cell is identical to a height of the negative electrode terminal of the bare cell.

7. The battery pack of claim 3, wherein the second connecting portion comprises a first area positioned on the second surface of the body portion, and a second area extending from the first area and configured to be bent along an axis of the first area.

8. The battery pack of claim 7, wherein the second area of the second connecting portion is configured to be bent perpendicularly with respect to the first area of the second connecting portion.

9. The battery pack of claim 7, wherein the second area of the second connecting portion extends in a direction away from the bare cell.

10. The battery pack of claim 7, wherein the second connecting portion further comprises an extending portion configured to electrically connect the second surface of the protective circuit module to the second connecting portion, and
wherein the extending portion comprises a first area electrically connected to and parallel with the second area of the second connecting portion, and a second area bent from the first area toward and electrically connected to the second surface of the protective circuit module.

11. The battery pack of claim 3, wherein a resistance of the body portion is changed in correlation with a temperature of the bare cell.

12. The battery pack of claim 1, wherein the bare cell comprises a negative electrode terminal, and wherein the first connecting portion is connected to the negative electrode terminal.
